(19) United States
(12) Patent Application Publication
(10) Pub. No.: US 2026/0235155 A1
(43) Pub. Date: Aug. 13, 2026

(54) FASTENER MOVEMENT DETECTION SYSTEM

(71) Applicant: Brett Wade, Weatherford, TX (US)

(72) Inventor: Brett Wade, Weatherford, TX (US)

(21) Appl. No.: 18/199,178

(22) Filed: May 18, 2023

Related U.S. Application Data
(60) Provisional application No. 63/343,870, filed on May 19, 2022.
(60) Provisional application No. 63/393,129, filed on Jul. 28, 2022.

(51) Int. Cl. F16B 41/00; G01P 15/18

(52) U.S. Cl. CPC F16B 41/002; G01P 15/18

(57) ABSTRACT

A fastener movement detection system has a housing holding at least one sensor including a gyroscope sensor, a wireless communication device, and a power source. The housing is configured to be attached onto an assembly fastener such as a nut or bolt. The wireless communication device is communicably coupled to a receiver unit. If the at least one sensor detects a movement of the housing beyond a specified range of motion, the wireless communication device sends an alert to the receiver unit.

### BACKGROUND

### 1. Field of the Invention

The present invention relates generally to monitoring systems, and more specifically to a system for detecting movement of a lug nut or other fasteners.

### 2. Description of Related Art

Nuts, bolts, and similar fasteners are well known in the art and are effective means to secure components to each other. One of the problems commonly associated with conventional nut fasteners is that they can become loosened from their intended position over time, potentially leading to catastrophic failure.

Accordingly, although great strides have been made in the area of fastener systems, many shortcomings remain. It is therefore an objective of the present invention to provide a fastener movement detection system that monitors the fastener or an associated fastener's position and sends an alert signal if movement is detected past a specified range of motion, and that can track and extract data to be review, and that can track and extract data to be reviewed for later recourse involving movement of the fastener.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective exploded view of an embodiment of the present invention; and

FIG. 2 is a schematic diagram of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional nut fasteners. Specifically, the system of the present invention monitors the position of a threaded nut and sends an alert if it is detected to have become displaced from its desired position, and can further track and display live telemetry of the movement of the threaded nut. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular Specification embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

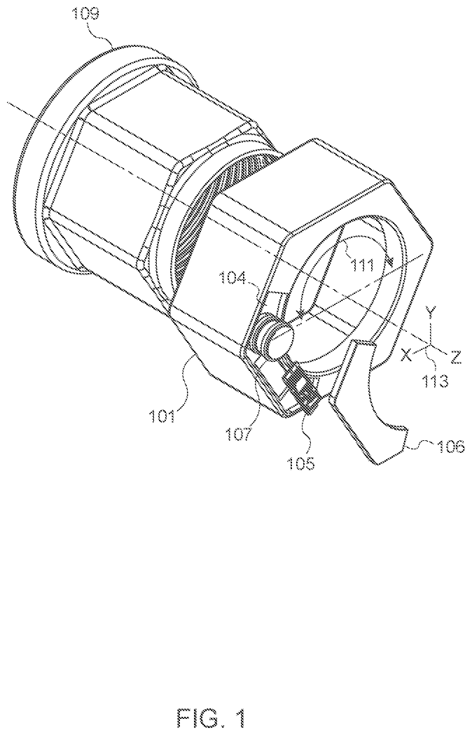

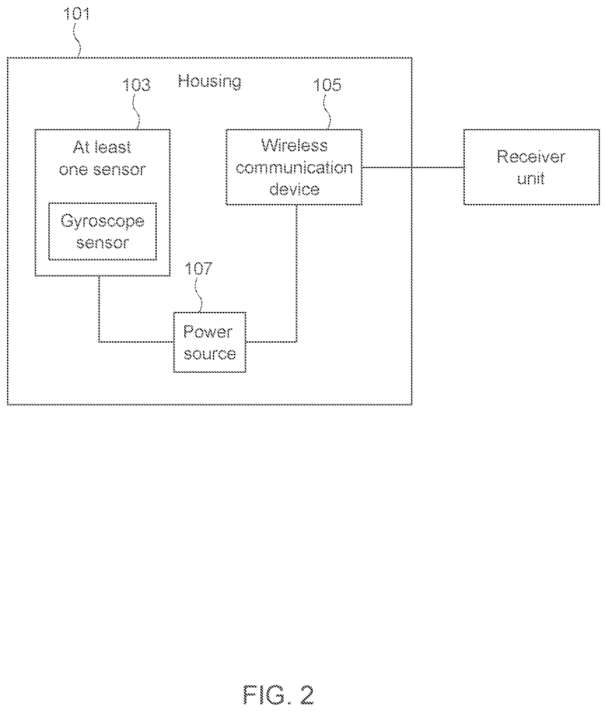

Referring now to the drawings wherein like reference characters identify corresponding or similar elements throughout the several views, FIGS. 1-2 depict an exploded perspective view and a schematic diagram in accordance with a preferred embodiment of the present application. It will be appreciated that the system of the present invention overcomes one or more of the above-listed problems commonly associated with conventional nut fasteners. In addition, it should be appreciated that more or fewer of such components may be included in different embodiments of the present invention.

In the contemplated embodiment, system includes a housing 101, wherein the housing 101 holds at least one sensor 103, a wireless communication device 105, and a power source 107 within a cavity 104, secured therein by a cap 106 or encapsulated with liquid-hardening seal. The housing 101 is configured to be attached to an assembly fastener 109, which can correspond to any applicable threaded nut or bolt fastener in a range of applications whose position needs to be monitored.

The housing 101 is preferably a high-temperature plastic polyethylene terephthalate glycol (PETG) with a temperature resistance of 85 degrees Celsius, though the material of the housing 101 may vary as desired in various embodiments. In the contemplated embodiment, the housing 101 is configured to be removably attached to the assembly fastener 109. To this end, the housing 101 may have an interior cavity shaped and dimensioned to receive an end of the assembly fastener 109 therein. This is Specification desirable for adding the monitoring capabilities of the present invention to an existing nut that may be already installed in its designated location and possibly also undesirable to remove to install the present invention thereupon. In an alternative embodiment, the housing 101 is permanently connected to the assembly fastener 109 such that a production unit is provided with the desired monitoring capabilities included.

In the contemplated embodiment, the power source 107 comprises one or more batteries; more specifically, the power source 107 comprises one or more coin batteries, which is a desirable form factor to minimize space usage. It is further contemplated that in some embodiments, the power source 107 may additionally or alternatively comprise an external wired or inductive power source as different applications may allow.

In the contemplated embodiment, the wireless communication device 105 is a radio frequency (RF) transceiver/control unit that utilizes any applicable RF communication protocol, such as, but not limited to Bluetooth, WiFi, or the like. The wireless communication device 105 is communicably coupled to a receiver unit, which may be further connected to a computing device or other system.

It should also be appreciated that one of the unique features believed characteristic of the present application is real-time monitoring of data measured by the at least one sensor 103 and transmitting/receiving the data through the at least one wireless communication device 105. The at least one the wireless communication device 105 is configured to send an alert signal to the receiver unit if the at least one sensor 103 detects movement of the housing beyond a specified range of motion 111. The present invention monitors in real time and/or stores the data being provided by the wireless communication device 105.

In the contemplated embodiment, the at least one sensor 103 comprises a 3-axis linear accelerometer capable of precisely measuring any change in angular orientation and/or g-force movement of the housing 101, thereby enabling calculation of the housing's 101 current orientation. The at least one sensor 103 may further comprise an accelerometer to measure position change along linear axes to augment the angular calculation, though the measurement of the housing's 101 angular orientation is Specification considered generally more important to the present invention as it relates to monitoring of the assembly fastener 109 coming loose from its associated lug or threaded bolt. Any desired direction-along various x, y, or z axes, as exemplified by coordinate system 113 -may be measured and monitored in various embodiments as relating to any relative positioning and/or orientation between fasteners. A z axis may be monitored in regards to stretching of threads or elongation of plain movement in orientation with any other device or equipment.

To this end, the specified range of motion 111 corresponds to an angular range of rotation of the housing. For example, a particular assembly fastener 109 may be understood to be dangerously loose if it rotates more than 180 degrees about the z axis of coordinate system 113 measured by the gyroscope sensor from its initial zero in a properly tightened down and torqued state.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof. The following is a complete listing of the claims and replaces all prior versions and listings of claims in the subject application. Please amend the claims as follows:

1. A fastener movement detection system for detecting rotational movement of a bolt, the system comprising:
a housing having an inner surface area that matches an exterior surface area of a head of the bolt, the housing forming a cavity having an interior surface that matches the exterior area of the head of the bolt such that the cavity snugly fits around the head of the bolt, the housing is removable secured solely to the exterior surface of the head of the bolt that engages with the cavity, the housing having:
a body that forms the cavity, the body is removably attached to the head of the bolt;
a linear accelerometer secured within the cavity and configured to sense rotational movement of the housing while secured to the bolt, the linear accelerometer is configured to sense changes in angular orientation and g-force movement of the housing relative to the bolt;
a receiver unit positioned remote from the housing;
a wireless communication device positioned within the cavity and in data communication with the receiver and the linear accelerometer, the wireless communication device is configured to transmit data from the linear accelerometer to the receiver; and
a cap that covers the cavity;
wherein the wireless communication device is configured to send an alert to the receiver unit if the linear accelerometer detects movement of the housing beyond a specified range of rotational motion.

2-5. (canceled)
